(19) United States
(12) Patent Application Publication
(10) Pub. No.: US 2016/0077277 A1
(43) Pub. Date: Mar. 17, 2016

(54) Light Core, in Particular for Flat Lighting Systems

(71) Applicant: Holger Kasper, Chemnitz (DE)

(72) Inventor: Holger Kasper, Chemnitz (DE)

(21) Appl. No.: 14/891,327

(22) PCT Filed: May 15, 2014
(86) PCT No.: PCT/DE2014/100167

§ 371 Date: Nov. 14, 2015

(30) Foreign Application Priority Data
May 15, 2013 (DE) 20 2013 004 668.6

(51) Int. Cl. F21V 8/00

(52) U.S. Cl. CPC G02B 6/0093; G02B 6/0073; G02B 6/0096

(57) ABSTRACT

The invention relates to a light core (1) especially used for flat lighting systems (S) comprising at least one element (1.1, 1.2, . . . 1.n), preferably made of a suitable transparent plastic, in particular acrylic glass (PMMA GS), wherein light (L) from at least one lamp (2) can be led into the light core (1) through at least one side edge or an end of the element (1.1 . . . ), and at least one element (1.1, 1.2 . . . ) of the light core (1) has at least one surface that is processed in such a way that damage areas are formed in it and the light from at least one light-emission area coupled in through the lamp (2) is radiated into the damage areas via refraction, wherein the density of the damage areas essentially uniformly decreases as per the invention in the direction of the side edge, or the end where the light is coupled in, from the direction of the opposite side edge or from the direction of the middle (M) of the light core (1).

### CROSS REFERENCE TO RELATED APPLICATIONS

This application is the U.S. national stage of International Application No. PCT/DE2014/100167, filed on May 15, 2014, and claims the benefit thereof. The international application claims the benefits of German Application No. DE 202013004668.6 filed on May 15, 2013; all applications are incorporated by reference herein in their entirety.

### BACKGROUND

The invention relates a light core that is used, in particular, for flat lighting systems, e.g. ultra-flat lighting systems.

Acrylic glass GS (PMMA GS) is used as a preference for the production of light cores for ultra-flat light glass plates made of glass material. This is an acrylic glass that is manufactured in a casting process and that is used wherever very high requirements are placed on optics, transparency and quality. Moreover, the diverse and excellent processing possibilities are to be especially emphasized. Plates made of PMMA GS usually have a thickness of approx. 12-12 mm. The thickness is also determined by the optical refraction angle and the weight.

In accordance with DE 20 2011 109 174, plates of that type made of PPMA GS are used as a light-active component for ultra-flat light plates. They can also be used as (so-called) light boxes, different ultra-flat light advertisements of all types and diverse light effects. The light cores (sandblasted) structured in sectors via sandblasting that are described in the above-mentioned document already have a good efficiency level and tend towards a stepped light structure that is usually concealed by transitions between the sectors x1 to x4. Light cores according to this prior art are shown in the drawings FIG. 3 and FIG. 4. Each blasted sector x1 t x4 is separated from the neighboring sector by the blasting intensity during the sandblasting. The processing is uniform within the sectors; there is a uniform distribution of damage in the respective sector x1 to x4 because of that. The light streams in on the side.

A relatively uniform illumination of the area on the glass surface can be realized with this solution, but this processing system hits its limits with large plates, e.g. in the case of a monochrome design (unicolors), with easily measured and also visible stepped light patterns in the material.

Furthermore, light glass plates (light cores) for which the light is deflected by foils with pressed-on, purely white dot patterns, as an example, are well-known. They only have a very low level of efficiency, so light plates that only operate well over a relatively small area can be manufactured with this technology.

A further well-known possibility is the generation of greater brightness at the edge of the glass where the light enters via particles with a lighting effect that are already mixed into the glass batch while the glass batch is still in a liquid state. The effect of a bright plate edge and a decreasing light intensity in the further progression arises because of that, so uniform radiation is not ensured over the entire surface. This variant is likewise hardly suitable for illumination of both sides because of the poor light values in the middle of the plate.

Light cores with a good level of efficiency whose glass surface was structured with a lighting effect via computer-controlled milling or laser technology are difficult to manufacture. A long processing time is meant by that.

The three above-mentioned examples are not intended to be included in that due to the designs, and they are not suitable for illumination of the light plate towards both sides (front and back side).

### SUMMARY

The invention relates to a light core (1) especially used for flat lighting systems (S) comprising at least one element (1.1, 1.2, . . . 1.n), preferably made of a suitable transparent plastic, in particular acrylic glass (PMMA GS), wherein light (L) from at least one lamp (2) can be led into the light core (1) through at least one side edge or an end of the element (1.1 . . . ), and at least one element (1.1, 1.2 . . . ) of the light core (1) has at least one surface that is processed in such a way that damage areas are formed in it and the light from at least one light-emission area coupled in through the lamp (2) is radiated into the damage areas via refraction, wherein the density of the damage areas essentially uniformly decreases as per the invention in the direction of the side edge, or the end where the light is coupled in, from the direction of the opposite side edge or from the direction of the middle (M) of the light core (1).

### DETAILED DESCRIPTION

The object of the invention is to develop a light core that can, in particular, be used for flat lighting systems, that ensures uniform radiation/emission of the coupled-in light over at least one surface area, in particular towards one or both sides, and that can be manufactured in a simple and cost-effective way.

This problem is solved by the characteristic features of the first claim.

Advantageous design forms follow from the sub-claims.

The light core is especially used for flat lighting systems made of at least one element, preferably made of a suitable transparent plastic, in particular acrylic glass (PMMA GS) or polymer glass; light from at least one lamp can be led into the light core through at least one side edge or an end of the element, and at least one element of the light core has at least one surface that is processed in such a way that damage areas are formed in it and the light from at least one light-emission area coupled in through the lamp is radiated into the damage areas via refraction, wherein the density of the damage areas essentially uniformly decreases as per the invention in the direction of the side edge, or the end where the light is coupled in, from the direction of the opposite side edge or from the direction of the middle of the light core.

Polymeric, light-transmitting molecular structures especially serve as suitable, transparent, light-transmitting plastics (transparent plastic, acrylic glass and polymer glass). A suitable type of plastic is consequently polycarbonate glass, as an example. High-quality polyester resins form the basis of polymer glass. Polymer glass is scratch-proof and has a high level of stability with regard to thermal and chemical effects, and it is substantially more robust compared to acrylic glass.

A light core made of Plexiglas, preferably PMMA GS or polymer glass, that is used, in particular, for ultra-flat lighting systems and that is provided with light, preferably LED light, at one or more of the glass edges is in a position due to the asymmetrical radiation of the glass surfaces (introduced by the blast processing) to emit this light towards one or even towards both sides; the light core is preferably comprised of one or more Plexiglas plate(s) GS, as a preference, with a thickness of approx. 2 to 12 mm.

The light core is processed via asymmetrical sandblasting, preferably with a CNC automatic blasting machine specially developed for that with corundum or quartz sand, field-proven as blasting agents, on one or both plate sides in such a way that there is a uniformly flowing transition from little blasting on the side where light enters, continuously increasing in blasting-process intensity, up to intensive blasting towards the middle of the plate when light enters at the opposite side or towards the end of the plate when light enters on one side.

The light core can be comprised of several plate-type elements in a sandwich design; the strongest blasting zone/processing zone is the middle of the plate in each case when the elements/light cores have light entering from the opposite side.

Furthermore, the light core or at least an element of the light core can be asymmetrically blasted/blasted with pattern masks solely in the areas where a light effect is required on the surface.

Limited or full-surface illumination of special/advertising messages, such as figures, text etc. is done with the light core as per the invention; the maximum possible level of uniformity in light emission arises because of the asymmetrical blast processing at all areas where the light is emitted.

If the light core is designed in the style of a sandwich light core and is consequently comprised of several elements in the form of Plexiglas plates with a thickness of 2 to 4 mm as a preference, each of these thin plates/elements can be asymmetrically blasted (blast processing) from one or from both sides; the elements are assembled (not glued) in an exposed way to form the light core.

The light core can have one or more of the elements that have been assembled to form the light core, that have been blasted in an evenly measured way with sandblasting and that have a uniform progression of the damage introduced via sandblasting.

Light cores with relatively small surfaces preferably have a uniform processing progression of the damage introduced via sandblasting because the blasting differences in that case are negligible with regard to the light emission.

Light does not enter these glass plates from the rear, as was customary up to now, but instead enters the glass from the side of the glass edges. The light deflection to the front areas of the glass is achieved via the surface damage to the glass core introduced in the asymmetrical or evenly measured manner described in the text below via sandblasting. Corundum and quartz sand have proven themselves for the sandblasting.

The damage introduced into the surface via the blast processing brightly illuminates when light streams in, and it thereby deflects the light entering from the side, because the damage interferes with the light refraction index/angle and changes it because of that.

With the characteristic feature: that the complete light plate, to operate well in emitting light from both sides, is usually comprised of a sandwich design made up of at least to main components. Preferably with an additional, usually scratch-proof, protective mineral glass plate in each case on the front side and on the back side of the light core. Alternatively, a different suitable material can also be used to protect the light core, for instance a transparent, tear-proof foil that is weatherproof for outdoor use. In this special case, the light core is simultaneously an image carrier in most applications. This structure can be used, for instance, as a fully transparent variant for glass doors, transparent room dividers etc. as examples.

In accordance with drawing page 1, FIG. 1, the light core plate 1 is completely or only partially asymmetrically blasted, e.g. also with asymmetrical blasting with pattern masks, for instance, to generate lettering or graphics (2 are the light source(s), 3 and 4 are preferably mineral glass plates here serving to protect against damage to the light core, or also image plates as desired and depending on the type of application). The protective plates are not necessary with regard to the actual operation.

To operate well, the light plates for the exclusive frontal emission of the light (light box) are comprised of at least four main components in a sandwich design.

See drawing page 1, FIG. 1 (1 light core-plate-shaped here, 2 lamp/light source, 3 back wall with a light-reflection layer in the direction towards the light core 1, 4 front plate with the image and, for good operation, usually provided with a white diffusion layer in the direction towards plate 1). The diffusion layer smooths pixels of the light core that arise.

Claim 1 involves a light core that is technically processed via sandblasting of one or both glass surfaces in such a way that the light, FIG. 1 and FIG. 2, streaming in because of the light source 2, as shown in FIG. 1, causes the plate 1 to uniformly light up.

The light core 1 can likewise be manufactured as a so-called sandwich made up of several plates that are processed with asymmetrical sandblasting (preferably at least two plates), FIG. 2; four elements 1.1., 1.2, 1.3 and 1.4 (core plates) that form the light core 1 are shown here in a sandwich structure.

The invention described in the claims:

(1) Is in a position to manufacture light cores*in a relatively short period of processing time via asymmetrical or evenly measured sandblasting of the surface(s) of the PMMA GS light core,

(2) To create a very uniform light progression (emission) over the entire glass surface via the technology that is described,

(3) If necessary, mere point-by-point, limited light effects can be produced via the asymmetrical or evenly measured blasting with pattern masks on the front glass surface that likewise ensure a high level of uniformity in the progression of light at the light-emission surfaces over the entire light core.

(4) Light cores with evenly measured blasting are a variation of the invention described in claim 1 that is preferably used for small-surface light cores.

(5) Instead of asymmetrical sandblasting, evenly measured blasting of the plate is used for especially small light cores as required, for instance, for illuminated house numbers or pictogram signs such as house numbers, emergency exist etc.

The invention will be explained in more detail below with the aid of accompanying drawings.

### BRIEF DESCRIPTION OF THE DRAWINGS

The following are shown in the figures:

FIG. 1 shows a lighting system S with a light core 1 using an element 1.1 in the form of a plate 1.1 and a plate 2 as reflectors, which is why the light core merely emits light to one side,

FIG. 2 shows the structure of a lighting system S with a light core 1 in a sandwich design using 4 elements 1.1 to 1.4,

FIGS. 3 and 4 show light cores according to the prior art,

FIGS. 5 and 6 show the emission sectors on the light core 1 and, in the process,

FIG. 5 shows an asymmetrical progression of the sandblasted surface of a light core 1 that is illuminated from a side c and

FIG. 6 shows a symmetrical progression of the sandblasted surface of a light core 1 that is illuminated by opposite side edges c and d,

FIG. 7 shows the front view of a light core 1 with a shape that is essentially circular,

FIG. 8 shows a three-dimensional representation of the light core 1 in accordance with FIG. 7 with switched-on lamps with a reflection layer on the back side 1b and an image on the front side 1a,

FIG. 9 shows the front view of an oval light core 1 in a non-illuminated state,

FIG. 10 shows a rod-shaped light core with lamps that radiate both ends f,

FIG. 11 shows the rod-shaped light core in an illuminated state,

FIG. 12 shows a tube-shaped light core 1 with lamps at one end f.

### DETAILED DESCRIPTION OF THE PREFERRED EMBODIMENT

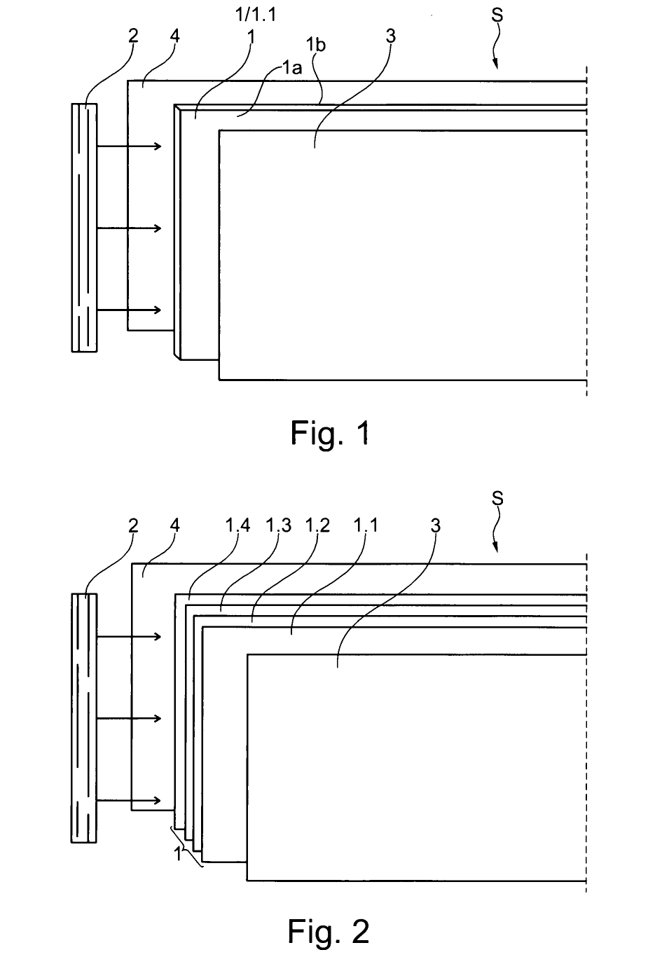

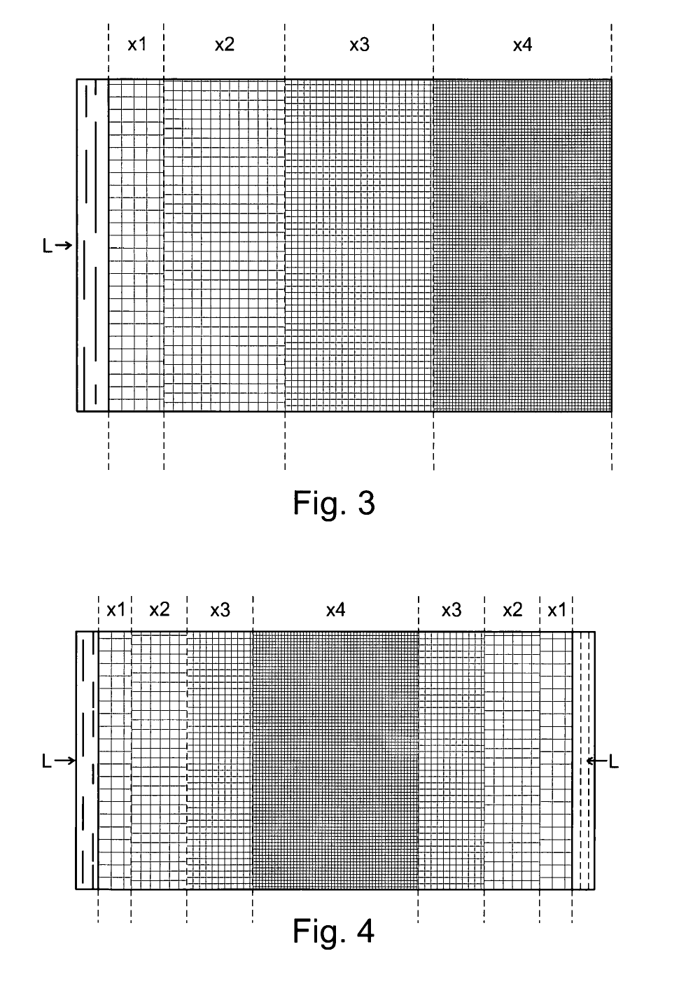

A lighting system S is shown in FIG. 1 that has a light core 1 in the form of an element 1.1 that is designed in the style of a rectangular plate.

If FIG. 1 is reinterpreted, the light core 1 (the light core 1 itself can also be used as an image carrier here) is protected against damage by front and rear plates 3 and 4, usually made of mineral glass. The system is transparent because of that and can be used from both sides. Protective foil can also be used instead of the plates 3 and 4. It is possible to likewise use one or both plates 3 and 4 as a light diffusion plate and as an image carrier. In that case, the light streams from light source 2 to light core 1 and uniformly from it to the diffusion and image plates 3 and 4.

FIG. 2 shows the structure of a lighting system S with a light core 1 in a sandwich design. In this example, the light core 1 is made of 4 plates (elements) 1.1, 1.2, 1.3 and 1.4 of asymmetrically blasted Plexiglas/acrylic glass GS (PMMA GS) here, preferably with a thickness of 2-4 mm per individual plate. The light core 1 sandwich that arises in that way has improved lighting results (light yield) as a consequence if more than one element or all of the elements 1.1 to 1.4 are supplied with lamps 2.Technically, the sandwich core operates in a fashion identical to the operation described above. Light emission to one or even to both sides 1a and 1b.

A light core 1 is comprised of at least one glass plate (preferably Plexiglas PMMA GS) or, in the sandwich lighting system that was described, of several elements/glass plates on top of one another into which the light streams laterally, i.e. from the direction of at least one side edge via one or more lamps 2, as shown in FIGS. 1 and 2. The light core 1 is technically manipulated (asymmetrically or in an evenly measured way, blasted with a suitable blasting agent—preferably sandblasted) in such a way that it emits the light that was received to the plate surfaces for the most part.

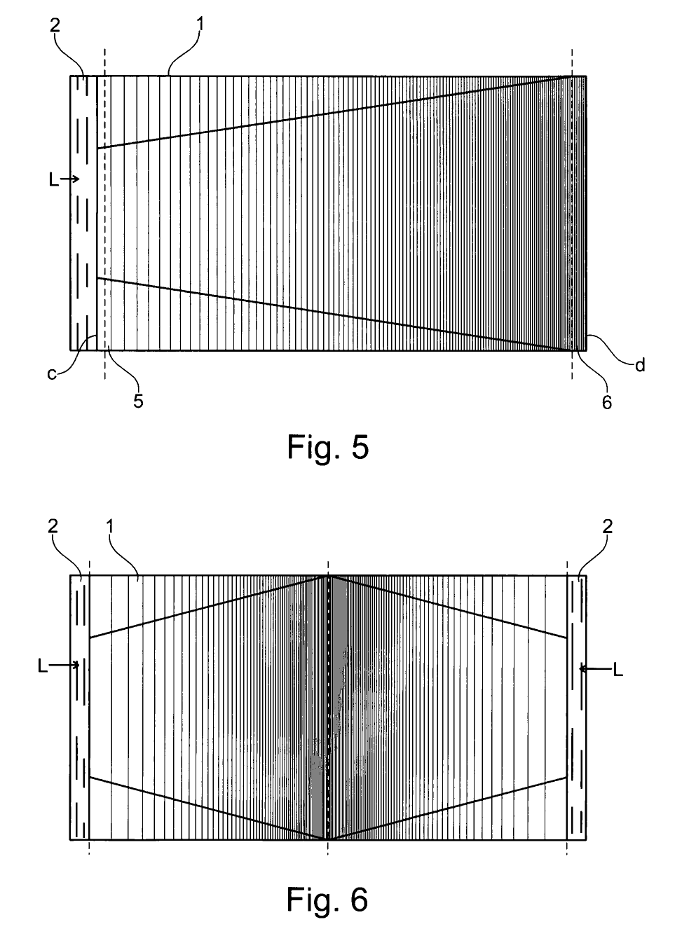

Asymmetrical sandblasting means that the surface 1 a and/or 1 b of the light core 1 is blasted with less intensity in the direction of the light entry area(s) than in the further progression in the direction of the middle or, in the case of one light source, towards the opposite end of the light core 1. The blasting intensity is preferably increased on a continuous basis, see the drawings FIG. 5 and FIG. 6.

The cone-like representation means a small area of low processing intensity that continuously increases in intensity towards the middle of the plate or the end of the plate. (The cone-shaped representation does not mean that the blasted surface is cone-shaped.)

In FIGS. 5 and 6, 2 is the lamp, 1 is the light core, 5 is the zone of least processing of the glass surface from the direction of the side edge c (FIG. 5) or c and d (FIG. 6) from which the light L emitted from the lamps 2 increasingly streams in towards zone 6=greatest processing of the glass surface. The progression of gray levels from bright to dark additionally documents the continuously increasing processing intensity.

The light starting from one of the lamps 2 is fed into the light core 1, in accordance with FIG. 5, from a side edge c in the direction of the opposite side edge d. Starting from the side c of the light incidence, there was a continuous, uniform increase in the processing intensity from Zone 5 to Zone 6 in the sandblasting, so the number of recesses/incidents of damage introduced into the surface by the sandblasting increases in the direction of the side edge d. More light is emitted in the areas with greater processing intensity because of that. If a lamp 2 that couples light L into the side edges c is attached in each case to opposite side edges c, d of the light core 1 in accordance with FIG. 6, the processing intensity during sandblasting starting from the side edges c, d is increased in the direction towards the middle line M of the light core, starting from Zone 5 towards Zone 6, causing the number of recesses/incidents of damage introduced into one or both surfaces 1b, 1c to increase in the direction of the middle of the light core 1.

The light incidence coupled into the side areas is uniformly emitted on the whole because of that through one or both surfaces of the light core 1, so light emission that is very uniform over the entire surface is ensured.

Evenly measured sandblasting means that the light core 1 is blasted without a light progression (uniformly over an entire surface or a surface section). These light cores that are blasted in such a way are preferably used in small light plates.

The intensity during sandblasting can be influenced by the movement speed of the sandblasting heads and/or the regulation of the processing pressure and/or the material volume of the blasting material.

If the light cores are used in light boxes, for instance, like those used for advertising, they only require approx. 20% of the energy in comparison with the customary systems of fluorescent tubes; substantial energy savings are possible because of that.

The light is preferably coupled in via lamps in the form of LEDS that are arranged along at least one edge of opposite edges of the light core. It is also possible to peripherally attach the LEDs on the side edges of the light core. The light core can be designed in the form of a polygon, but also round or oval.

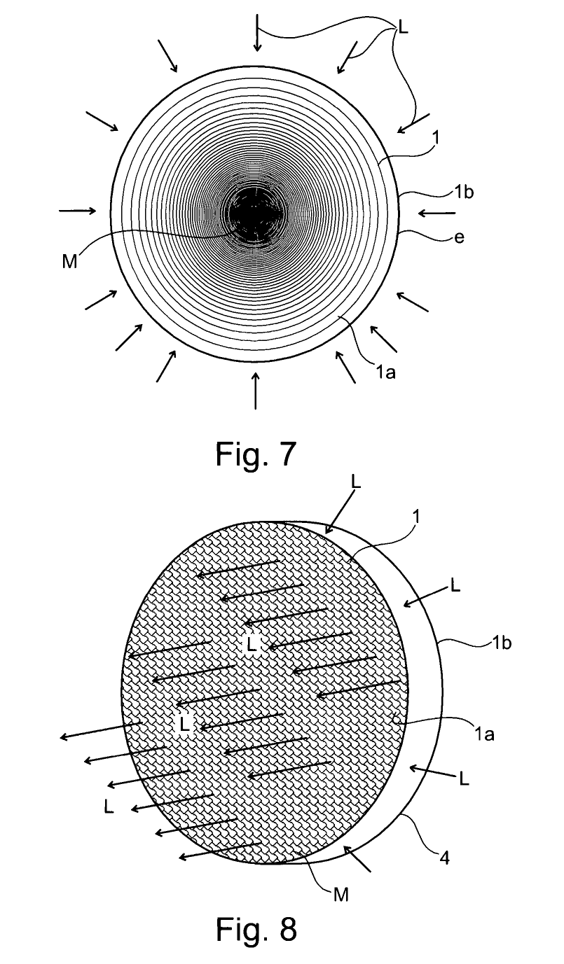

FIG. 7 shows, as an example, the front view of a light core 1 with an essentially circular shape, whose front side 1a has not been processed and whose back side 1b has been processed via sandblasting in such a way that the processing intensity and consequently the damage increases in the direction of the middle M, which is illustrated by the gray shadowing that gets darker in the direction of the middle M. The light L is essentially coupled in over the entire circumference of the side edge 1b via lamps that are not shown here.

The three-dimensional representation of a lighting system S (without lamps) using a light core 1 in accordance with FIG. 7 with switched-on lamps with a reflection layer on the back side 1b and an image on the front side 1a is shown in FIG. 8. The light L coupled in through the side 1a is emitted in a surprisingly uniform way through the front side 1a, and the image M is evenly illuminated, because of the processing intensity that increases in the direction of the middle.

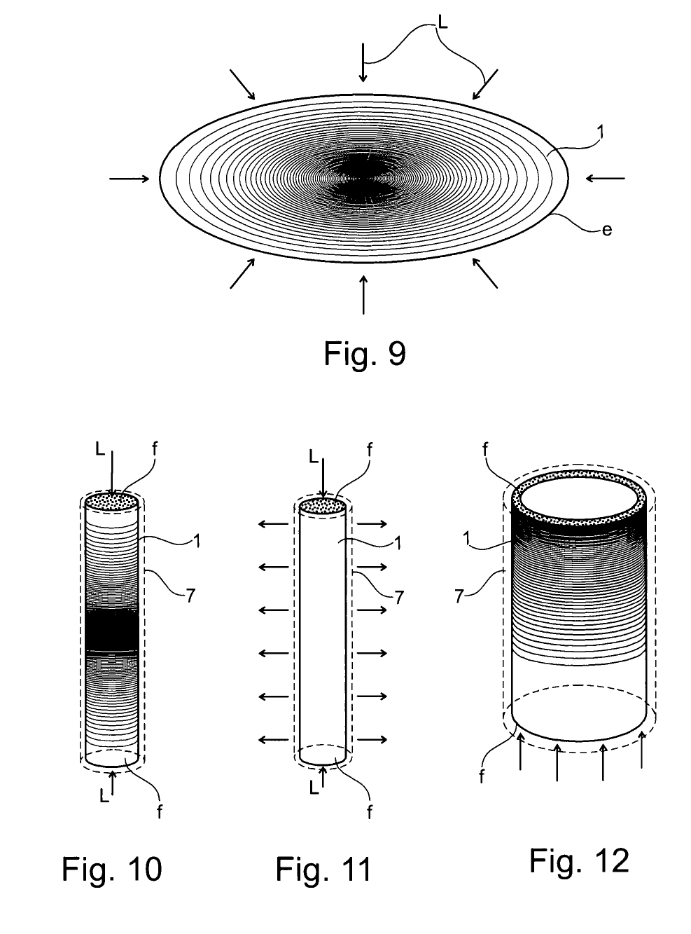

FIG. 9 shows the front view of an oval light core 1 in an unlighted state; the light L can be coupled into its run-around side edge e. The processing intensity during sandblasting of one or both surfaces was likewise increased towards the middle.

Furthermore, it is possible to use a rod or tube-shaped light core 1. The LEDs are then arranged on one end or on both ends of the rod or tube, and the rod or tube is processed via sandblasting around the circumference and, if necessary, combined with decoration and/or protection around the circumference. A special 3D effect can brought about because of that.

FIG. 10 shows a rod-shaped light core 1 with lamps that are arranged so as to radiate in at both ends f in an unlighted state. The processing intensity during the sandblasting around the circumference was increased in the direction of the middle M of the rod, which is indicated by the progression that gets darker. The rod (light core 1) is surrounded by a protective casing 7 that can be designed in the form of a transparent coating, foil or tube. The rod-shaped light core 1 is shown in a lighted state in FIG. 11 in which the light L coupled in through the ends f is very uniformly emitted over the entire circumference of the rod-shaped light core 1.

It is alternatively possible to couple the light into the rod-shaped light core at only one end. The processing intensity of the blasted circumferential surface increases up to the other end.

FIG. 12 shows a tube-shaped light core 1 with lamps (not shown) that couple in the light L at one end f. The processing intensity of the blasted circumferential surface then increases up to the other end f (illustrated by the progression of shadowing that gets darker).

When a tube-shaped light core 1 is used, it will likewise advantageously be provided with a white reflection layer on its inner diameter, not shown here, which is either directly applied to the inner diameter or that is formed by a white element on the surface of the inner diameter.

The light cores in the form of glass rods or tubes can also be bent into any desired form before or after the processing via a corresponding blasting process.

It is possible in general to also use other suitable lamps instead of LEDs or to couple in the light via optical fibers/fiber-optic cables (for instance glass-fiber cables). The light core can, in combination with the lamps coupling in the light, serve as a plate with corresponding fastening systems for surface illumination for walls, ceilings, floors or partition walls or even in a suspended form as area lighting. A reflection pate or foil that is white in the direction of the light core is preferably arranged on the back side of the light core.

If light cores are made up of several plates, they are not permitted to be adhered to the sandblasted surfaces. Adherence of the plates to items is possible in the unprocessed/non-blasted edge area. It is possible to manufacture lighting systems as per the invention for advertising purposes using the light core that emit the light towards one or both sides if they have a flat design and are provided with corresponding advertising space.

The advertisement can be directly printed on a preferably unprocessed side of the light core or of an element of the light core. If the light is coupled from the direction of one or both ends via the lamp into a rod or tub-shaped light core that has been processed around the circumference with sandblasting, this light core will emit the light over its entire circumference. If the light core was printed or otherwise provided with an advertising message in the area of its circumference, a completely new advertising will be created because of that.

1. Light core (1) comprising at least one element (1.1, 1.2, . . . 1.n) made of transparent plastic, wherein light (L) from at least one lamp (2) can be led into the light core (1) through at least one side edge or an end of the element (1.1 . . . ), and at least one element (1.1, 1.2 . . . ) of the light core (1) has at least one surface that is processed in such a way that damage areas are formed in it via blast processing and the light from at least one light-emission area coupled in through the lamp (2) is radiated into the damage areas via refraction, characterized in that the density of the damage areas introduced by the blast processing essentially uniformly decreases in the direction of the side edge, or the end where the light is coupled in, from the direction of the opposite side edge or from the direction of the middle (M) of the light core (1) and that the light core is comprised of one or more elements
that are asymmetrically blasted from one or both sides or
that the elements are blasted in an evenly measured way and have a uniform progression of the damage introduced by that or
that the light core (1) or at least an element of the light core (1) is asymmetrically blasted solely in the areas where a light effect is required on the surface.

2. Light core according to claim 1, characterized in that it is comprised of one or more plates made of plexiglass or PMMA GS for ultra-flat lighting systems (S) that are provided with light ((L), preferably LED light, at one or more of the glass edges and that are in a position due to the asymmetrical blasting of the glass surfaces to emit this light (L) towards one or towards both sides, wherein the light core (1) is comprised of one or more plates (1.1, 1.2, 1.3 . . . 1.n) with a thickness of 2 to 12 mm.

3. Light core according to claim 1, characterized in that the light core is processed via asymmetrical sandblasting on one or both plate sides (1a, 1b) in such a way that there is a uniformly flowing transition from little blasting on the side where light enters, continuously increasing in blasting-process intensity, up to intensive blasting towards the middle of the plate when light enters at the opposite side or towards the end of the plate when light enters on one side.

4. Light core according to claim 1, characterized in that the light core (1) is comprised of several elements in a sandwich form, and the strongest blasting zone/processing zone is the middle of the plate when there is light incidence on opposite sides of the elements/light cores (1).

5. Light core according to claim 1, characterized in that there is a limited illumination of special/advertising messages such as figures, lettering etc. with this and the maximum possible level of uniformity in light emission arises because of the asymmetrical blast processing at all areas where the light is emitted.

6. Light core according to claim 1, characterized in that it is designed in the style of a sandwich light core and is comprised of several elements in the form of plexiglass plates with a thickness of 2 to 4 mm, wherein the elements are assembled and not glued in an exposed way to form the light core.

7. Light core according to claim 1, characterized in that it is has a plate-type design and a polygonal, round or oval shape and that the light core is provided with a protective plate or protective foil.

8. Light core according to claim 1, characterized in that it has a reflection layer on a back side (1b) and an image on a front side (1a).

9. Light core according to claim 1, characterized in that it is designed to be rod or tub-shaped and that lamps are arranged at one end or at both ends of the rod or tube and that the rod or the tube is processed around the circumference via sandblasting.

10. Light core according to claim 9, characterized in that the rod or the tube is provided with a decoration and/or protection around the circumference.

11. Light core according to claim 9, characterized in that the inner diameter of a tube-shaped light core is provided with a white reflection layer that is either directly applied to the inner diameter or that is formed from a white element introduced to the surface of the inner diameter.

12. Light core according to claim 9, characterized in that light cores in the form of glass rods or tubes are bent into any desired shape before or after the processing via a blasting process.
